(19) United States
(12) Patent Application Publication
(10) Pub. No.: US 2011/0227845 A1
(43) Pub. Date: Sep. 22, 2011

(54) METHOD FOR CONTROLLING AN ELECTRONIC DEVICE THAT INCLUDES A TOUCH PAD AND A DISPLAY SCREEN, AND THE ELECTRONIC DEVICE

(75) Inventors: JAOCHING LIN, TAIPEI CITY (TW); WEN-TING LEE, NEW TAIPEI CITY (TW); LINABEL CHU, TAIPEI CITY (TW)

(73) Assignee: SENTELIC CORPORATION, TAIPEI CITY (TW)

(21) Appl. No.: 13/046,093

(22) Filed: Mar. 11, 2011

(30) Foreign Application Priority Data
Mar. 17, 2010 (TW) 099107815
Dec. 30, 2010 (TW) 099146894

(51) Int. Cl. G06F 3/041

(52) U.S. Cl. 345/173

(57) ABSTRACT

A method for controlling an electronic device includes the steps of: upon detecting a single-object touch on a touch pad when the electronic device operates in a cursor mode, where movement of a cursor in a visual display displayed on the display screen is enabled and controlled in response to and in correspondence with a single-object sliding touch motion on the touch pad, configuring the electronic device to determine whether a time interval that the single-object touch remains substantially stationary on the touch pad reaches a predefined threshold value; and when it is determined that the time interval reaches the predefined threshold value, configuring the electronic device to exit the cursor mode and enter a scrolling mode, where scrolling of the visual display is enabled and controlled in response to and in correspondence with a single-object sliding touch motion on the touch pad.

### CROSS-REFERENCE TO RELATED APPLICATION

This application claims priority of Taiwanese Application Nos. 099107815 and 099146894, filed on Mar. 17, 2010 and Dec. 30, 2010, respectively.

### BACKGROUND OF THE INVENTION

1. Field of the Invention

The invention relates to a touch control device and method, more particularly to a method for controlling an electronic device that includes a touch pad and a display screen.

2. Description of the Related Art

U.S. Pat. No. 5,943,052 discloses a touch pad that is configured with a cursor zone for user input of a touch motion by an object (e.g., the user's finger) to control movement of a cursor on a visual display displayed on a display screen, and a scrolling zone disposed along a side edge of the touch pad for user input of a sliding motion by the object to control scrolling of the visual display displayed on the display screen. In order to avoid accidental scrolling of the visual display when controlling the cursor, the scrolling zone is normally disposed along a side edge of the touch pad and is limited in size, which can generally only accommodate one finger in width. As such, the success rate of scrolling the visual display depends on the movement of the user's finger along the side edge and within the scrolling zone. Once the user's finger slips out of the scrolling zone, the scrolling of the visual display would be ended, while the cursor might be undesirably moved. Moreover, although the scrolling zone is a defined zone on the touch pad, there are generally no clear boundaries between the cursor zone and the scrolling zone, such that when the user wishes to control movement of the cursor by moving the finger in the cursor zone, there is still a great chance that the finger unintentionally touches the scrolling zone. Conventionally, some touch pads are provided with a protruding frame that separates the cursor zone from the scrolling zone. However, due to aesthetic and size considerations, recent touch pads mostly adopt the design where the touch pad is completely leveled with a housing of an electronic device incorporating the touch pad. Therefore, the user has to keep his/her eyes on the touch pad at all times both to move the cursor and to scroll the visual display, which is very inconvenient.

### SUMMARY OF THE INVENTION

Therefore, the object of the present invention is to provide a method for controlling an electronic device that includes a touch pad and a display screen, and an electronic device that can eliminate the aforesaid drawbacks of the prior art.

According to one aspect of the present invention, there is provided a method for controlling an electronic device that includes a touch pad and a display screen. The method includes the steps of:

(A) upon detecting a single-object touch on the touch pad when the electronic device operates in a cursor mode, where movement of a cursor in a visual display displayed on the display screen is enabled and controlled in response to and in correspondence with a single-object sliding touch motion on the touch pad, configuring the electronic device to determine whether a time interval that the single-object touch remains substantially stationary on the touch pad reaches a predefined first threshold value; and

(B) when it is determined that the time interval that the single-object touch remains substantially stationary on the touch pad reaches the predefined first threshold value, configuring the electronic device to exit the cursor mode and enter a scrolling mode, where scrolling of the visual display displayed on the display screen is enabled and controlled in response to and in correspondence with a single-object sliding touch motion on the touch pad.

Preferably, the method further includes the step of: (C) when it is determined that the time interval that the single-object touch remains substantially stationary on the touch pad has not reached the predefined first threshold value, configuring the electronic device to remain in the cursor mode.

Preferably, the method further includes the step of: (D) upon determining that a time interval that, no touch is detected on the touch pad reaches a predefined second threshold value when the electronic device operates in the scrolling mode, configuring the electronic device to exit the scrolling mode and return to the cursor mode.

More preferably, the method further includes the step of: (E) configuring the electronic device to permit user setting of the predefined first and second threshold values.

Preferably, the method further includes the step of: (F) upon detecting one of a double-object touch, a single-object double tap, a double-object pinching and a single-object dragging touch motion on the touch pad when the electronic device operates in the scrolling mode, configuring the electronic device to exit the scrolling mode and enter the cursor mode to perform a function in response to and in correspondence with the one of the double-object touch, the single-object double tap, the double-object pinching and the single-object dragging touch motion on the touch pad.

Alternatively, the touch pad is configured with a scrolling zone and a cursor zone. The movement of the cursor in the visual display shown on the display screen is enabled and controlled in response to and in correspondence with a single-object sliding touch motion on the cursor zone of the touch pad when the electronic device operates in the cursor mode.

Alternatively, with the touch pad configured with a scrolling zone and a cursor zone, the single-object touch detected in step (A) is on the scrolling zone of the touch pad, the time interval determined in step (B) corresponds to a time interval that the single-object touch remains substantially stationary on the scrolling zone of the touch pad, and scrolling of the visual display shown on the display screen is enabled and controlled in response to and in correspondence with a single-object sliding touch motion on the scrolling zone of the touch pad when the electronic device operates in the scrolling mode.

In this case, preferably, the method further includes the step of: (G) upon detecting that there is no touch on the scrolling zone of the touch pad and that there is a touch on the cursor zone of the touch pad when the electronic device operates in the scrolling mode, configuring the electronic device to exit the scrolling mode and enter the cursor mode.

Preferably, the method further includes the step of: (H) upon detecting that there is simultaneously a single-object touch on the cursor zone of the touch pad and a single-object touch on the scrolling zone of the touch pad when the electronic device operates in the scrolling mode, configuring the electronic device to exit the scrolling mode and enter the cursor mode.

Preferably, the method further includes the step of: (I) upon detecting one of a double-object touch, a single-object double tap, a double-object pinching and a single-object dragging touch motion on the cursor zone of the touch pad when the electronic device operates in the scrolling mode, configuring the electronic device to exit the scrolling mode and enter the cursor mode to perform a function in response to and in correspondence with the one of the double-object touch, the single-object double tap, the double-object pinching and the single-object dragging touch motion on the touch pad.

Preferably, the method further includes the step of: (J) configuring the electronic device to generate a graphic indication indicative of scrolling and shown in the visual display displayed on the display screen when the electronic device operates in the scrolling mode. Alternatively, the method further includes the step of: (K) configuring the electronic device to permit user setting of the scrolling zone.

According to another aspect of the present invention, there is provided an electronic device that includes a touch pad, a display screen, a processor and a control module. The touch pad is for generating a touch signal. The display screen is for displaying a visual display thereon. The processor is coupled to the touch pad for receiving the touch signal, and is further coupled to the display screen for generating the visual display to be displayed on the display screen. The processor enables and controls movement of a cursor in the visual display in response to and in correspondence with the touch signal that corresponds to a single-object sliding touch motion on the touch pad when the processor operates in a cursor mode. The processor enables and controls scrolling of the visual display in response to and in correspondence with the touch signal that corresponds to a single-object sliding touch motion on the touch pad when the processor operates in a scrolling mode. The control module is coupled to the touch pad for receiving the touch signal therefrom, and is further coupled to the processor for controlling operation of the processor in one of the cursor mode and the scrolling mode.

When the control module controls the processor to operate in the cursor mode, upon receipt of the touch signal indicating a single-object touch on the touch pad, the control module determines whether a time interval that the single-object touch remains substantially stationary on the touch pad reaches a predefined first threshold value with reference to the touch signal, and controls the processor to exit the cursor mode and enter the scrolling mode when the time interval that the single-object touch remains substantially stationary on the touch pad is determined to have reached the predefined first threshold value.

Preferably, the predefined first threshold value is user-defined.

Preferably, when the control module controls the processor to operate in the scrolling mode, upon receipt of the touch signal that indicates one of a double-object touch, a single-object double tap, a double-object pinching and a single-object dragging touch motion on the touch pad, the control module controls the processor to exit the scrolling mode and enter the cursor mode, where the processor is enabled to perform a function in correspondence with the one of the double-object touch, the single-object double tap, the double-object pinching and the single-object dragging touch motion on the touch pad with reference to the touch signal.

Preferably, the touch pad is configured with a scrolling zone and a cursor zone. The processor controls the movement of the cursor in the visual display displayed by the display screen in response to and in correspondence with the touch signal that corresponds to a single-object sliding touch motion on the cursor zone of the touch pad when operating in the cursor mode.

Alternatively, the touch pad is configured with a scrolling zone and a cursor zone. When the control module controls the processor to operate in the cursor mode, upon receipt of the touch signal indicating a single-object touch on the scrolling zone of the touch pad, the control module determines whether a time interval that the single-object touch remains substantially stationary on the scrolling zone of the touch pad reaches the predefined first threshold value, and controls the processor to exit the cursor mode and enter the scrolling mode when the time interval that the single-object touch remains substantially stationary on the scrolling zone of the touch pad is determined to have reached the predefined first threshold value. More preferably, the scrolling zone is user-defined.

Preferably, when the control module controls the processor to operate in the scrolling mode, upon receipt of the touch signal indicating that there is no touch on the scrolling zone of the touch pad and there is a touch on the cursor zone of the touch pad, the control module controls the processor to exit the scrolling mode and enter the cursor mode.

Preferably, when the control module controls the processor to operate in the scrolling mode, upon receipt of the touch signal indicating that there is simultaneously a single-object touch on the cursor zone of the touch pad and a single-object touch on the scrolling zone of the touch pad, the control module controls the processor to exit the scrolling mode and enter the cursor mode.

Preferably, when the control module controls the processor to operate in the scrolling mode, upon receipt of the touch signal that indicates one of a double-object touch, a single-object double tap, a double-object pinching and a single-object dragging touch motion on the touch pad, the control module controls the processor to exit the scrolling mode and enter the cursor mode, where the processor is enabled to perform a function in correspondence with the one of the double-object touch, the single-object double tap, the double-object pinching and the single-object dragging touch motion on the touch pad.

Preferably, the electronic device further includes a light indicator coupled to the control module. The light indicator is activated by the control module when the processor enters the scrolling mode, and is deactivated by the control module when the processor exits the scrolling mode.

Preferably, the touch pad is a transparent touch panel that is laid over the display screen such that the touch pad and the display screen are integrated into a touch screen.

Preferably, the processor generates a graphic indication indicative of scrolling and shown in the visual display displayed by the display screen when the processor operates in the scrolling mode.

Preferably, when the control module controls the processor to operate in the scrolling mode, upon determining that a time interval that the touch signal indicating that no touch is detected on the touch pad has reached a predefined second threshold value, the control module controls the processor to exit the scrolling mode and return to the cursor mode. More preferably, the electronic device further includes a counter coupled to the control module for keeping track of the time intervals of the touch signal. Preferably, the predefined first and second threshold values are user-defined.

In addition, the cursor mode may serve as a default mode.

By monitoring the time interval that the object remains substantially stationary on the touch pad, and by monitoring the time interval that there is no touch on the touch pad, the present invention permits switching of the electronic device between the cursor mode and the scrolling mode, thus facilitating convenient user control under the cursor mode and the scrolling mode, while eliminating the drawbacks of the prior art.

### BRIEF DESCRIPTION OF THE DRAWINGS

Other features and advantages of the present invention will become apparent in the following detailed description of the preferred embodiments with reference to the accompanying drawings, of which:

FIG. 1 is a flowchart illustrating the method for controlling an electronic device according to the first preferred embodiment of the present invention;

FIG. 2 is a schematic block diagram illustrating the electronic device according to the first preferred embodiment of the present invention;

FIG. 3 is a schematic diagram illustrating control of movement of a cursor on a visual display displayed on a display screen corresponding to a single-object sliding touch motion on a touch pad when the electronic device operates in a cursor mode according to the first preferred embodiment;

FIG. 4 is a schematic diagram illustrating control of scrolling of the visual display displayed on the display screen corresponding to a single-object sliding touch motion on a touch pad when the electronic device operates in a scrolling mode according to the first preferred embodiment;

FIG. 5 is a schematic diagram illustrating a double-object touch on a touch pad according to the first preferred embodiment;

FIG. 6 is a schematic diagram illustrating an implementation where the touch pad and the display screen are integrated into a touch screen, and illustrating graphic indication indicative of scrolling and shown in the visual display according to the first preferred embodiment;

FIG. 7 is a schematic diagram illustrating the touch pad according to the second preferred embodiment of the present invention, where the touch pad is configured with a scrolling zone and a cursor zone;

FIG. 8 is a schematic diagram illustrating simultaneous two single-object touches respectively on the cursor zone and the scrolling zone of the touch pad according to the second preferred embodiment; and

FIG. 9 is a schematic diagram illustrating a double-object touch on the cursor zone of the touch pad according to the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

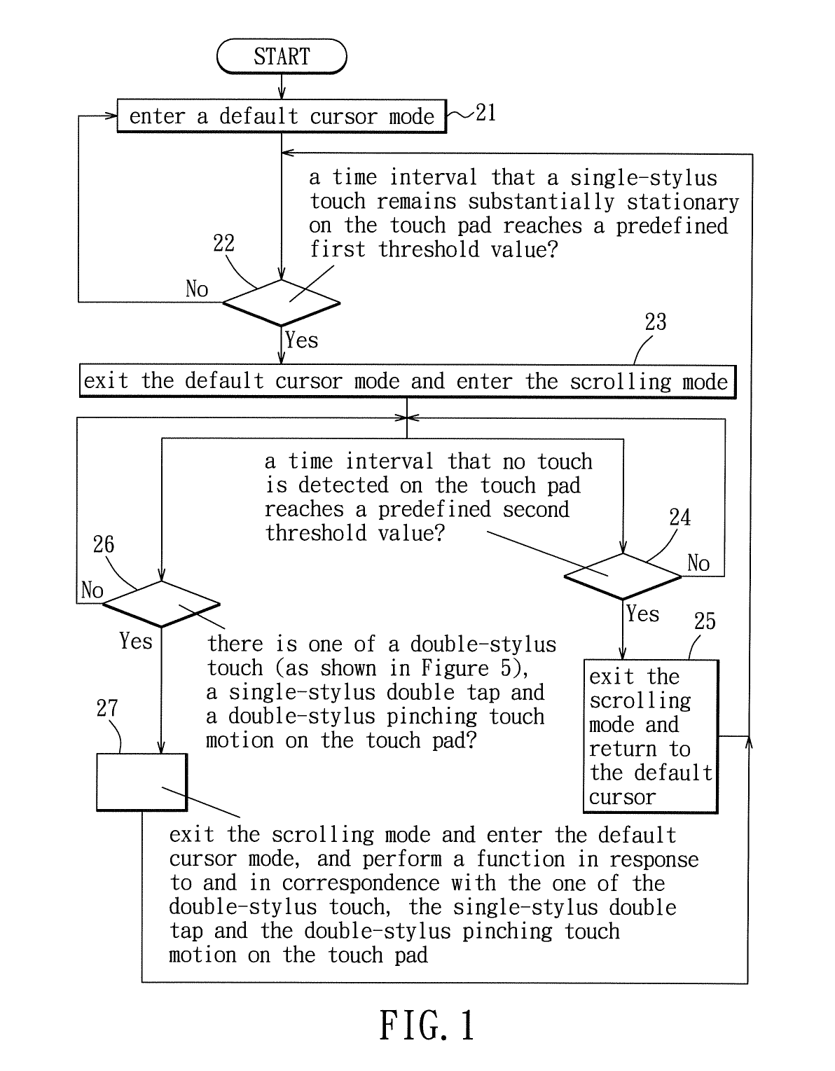

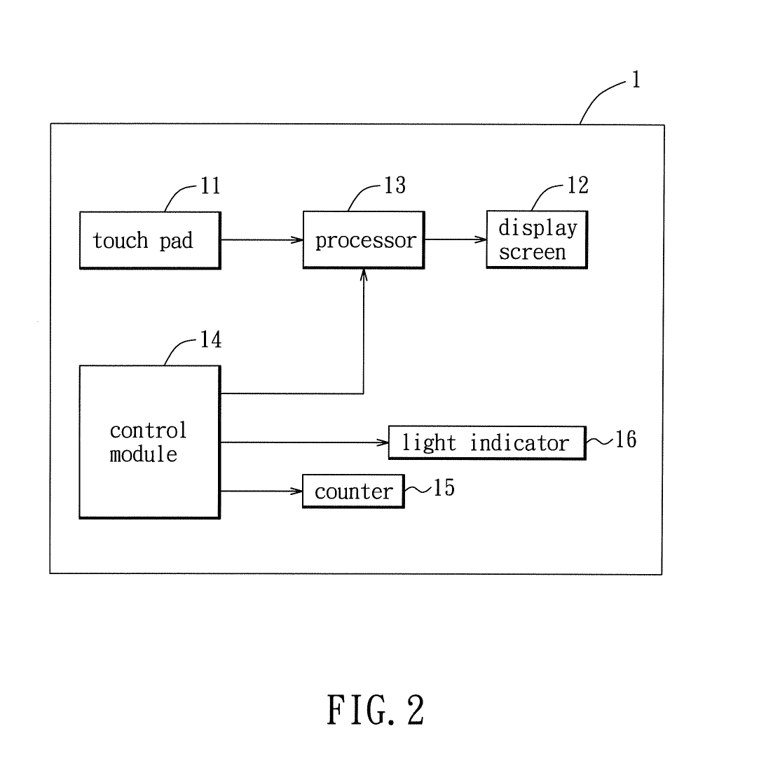

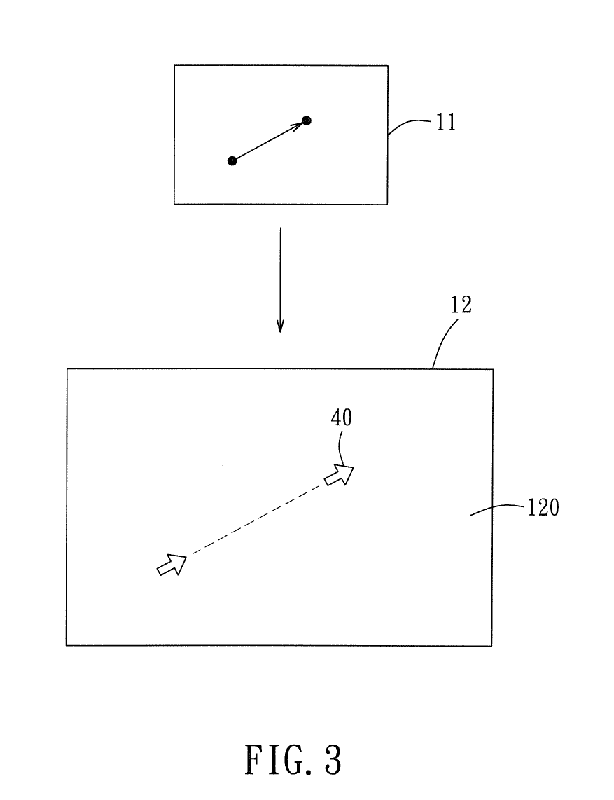

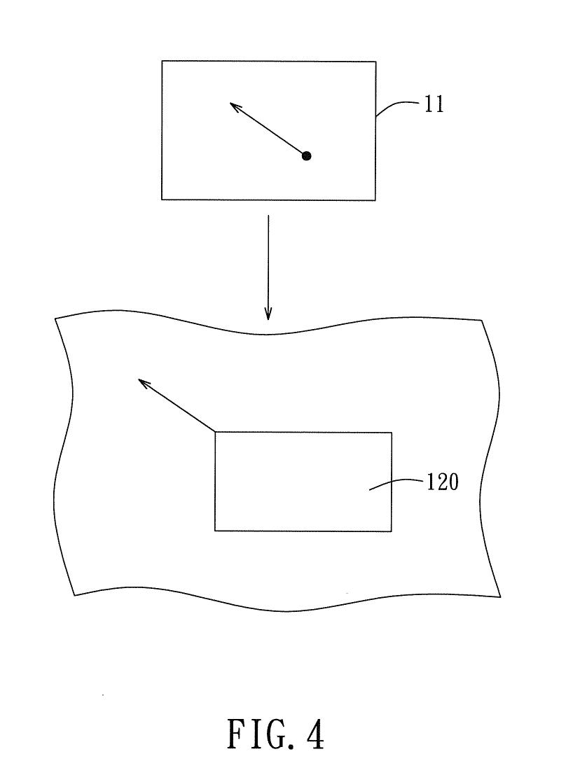

With reference to FIG. 1 and FIG. 2, a method for controlling an electronic device 1 that includes a touch pad 11 and a display screen 12 according to the first preferred embodiment of the present invention is disclosed. The electronic device 1 further includes a processor 13 and a control module 14. The touch pad 11 is used for generating a touch signal. The display screen 12 is used for displaying a visual display 120 (see FIG. 3) thereon. The processor 13 is coupled to the touch pad 11 for receiving the touch signal, and is further coupled to the display screen 12 for generating the visual display 120 to be displayed on the display screen 12. The processor 13 enables and controls movement of a cursor 40 (see FIG. 3) in the visual display 120 in response to and in correspondence with the touch signal that corresponds to a single-object sliding touch motion on the touch pad 11 when the processor 13 operates in a cursor mode (as shown in FIG. 3). The processor 13 enables and controls scrolling of the visual display 120 in response to and in correspondence with the touch signal that corresponds to a single-object sliding touch motion on the touch pad 11 when the processor 13 operates in a scrolling mode (as shown in FIG. 4, where the curvy block represents an apparently greater image that is not wholly displayed on the display screen 12 (as shown in FIG. 2), while the visual display 120 is the user-viewable portion of this greater image). The control module 14 is coupled to the touch pad 11 for receiving the touch signal therefrom, and is further coupled to the processor 13 for controlling operation of the processor 13 in one of the cursor mode and the scrolling mode.

Once the electronic device 1 is activated, the method for controlling the electronic device 1 according to the present invention begins, and includes the following steps.

In step 21, the electronic device 1 is configured to enter the cursor mode, or more specifically, the control module 14 controls the processor 13 to operate in the cursor mode, so as to enable movement of the cursor 40 on the visual display 120. As shown in FIG. 3, in the cursor mode, the cursor 40 may be moved in any direction corresponding to a single-object sliding touch motion on the touch pad 11.

In step 22, upon detecting a single-object touch on the touch pad 11 with reference to the touch signal generated by the touch pad 11, the electronic device 1 is configured to determine whether a time interval that the single-object touch remains substantially stationary on the touch pad 11 reaches a predefined first threshold value.

If it is determined in step 22 that the time interval that the single-object touch remains substantially stationary on the touch pad 11 reaches the predefined first threshold value, the flow goes to step 23, where the electronic device 1 is configured to exit the cursor mode and enter the scrolling mode. As shown in FIG. 4, in the scrolling mode, the visual display 120 may be scrolled in any direction corresponding to a single-object sliding touch motion on the touch pad 11.

If it is determined that the time interval that the single-object touch remains substantially stationary on the touch pad 11 has not yet reached the predefined first threshold value, the flow goes back to step 21, such that the electronic device 1 is configured to remain in the cursor mode.

In this embodiment, step 22 is performed upon receipt of the touch signal indicating a single-object touch on the touch pad 11, and the determination of whether the time interval that the single-object touch remains substantially stationary on the touch pad 11 reaches the predefined first threshold value is performed by the control module 14 with reference to the touch signal. In step 23, the control module 14 controls the processor 13 to exit the cursor mode and enter the scrolling mode.

In this embodiment, the method further includes the following steps.

In step 24, while the electronic device 1 operates in the scrolling mode (more specifically, while the control module 14 controls the processor 13 to operate in the scrolling mode), the electronic device 1 is configured to determine whether a time interval that no touch is detected on the touch pad 11 since the single-object touch leaves the touch pad 11 reaches a predefined second threshold value. For example, assuming that the object is a finger, as the finger leaves the touch pad 11, the time interval for no touch begins to be counted.

If it is determined that the time interval that no touch is detected on the touch pad 11 reaches the predefined second threshold value, the flow goes to step 25, where the electronic device 1 is configured to exit the scrolling mode and return to the cursor mode. More specifically, if it is determined that, when the control module 14 controls the processor 13 to operate in the scrolling mode, the time interval that the touch signal indicating that no touch is detected on the touch pad 11 has reached the predefined second threshold value, the control module 14 controls the processor 13 to exit the scrolling mode and return to the cursor mode. The flow continues to go from step 25 back to step 22 to detect the presence of a single-object touch on the touch pad 11, and to determine whether the time interval that the single-object touch remains substantially stationary on the touch pad 11 reaches the predefined first threshold value.

If it is determined that the time interval that no touch is detected on the touch pad 11 does not reach the predefined second threshold value, the flow goes to step 23, such that the electronic device 1 remains in the scrolling mode.

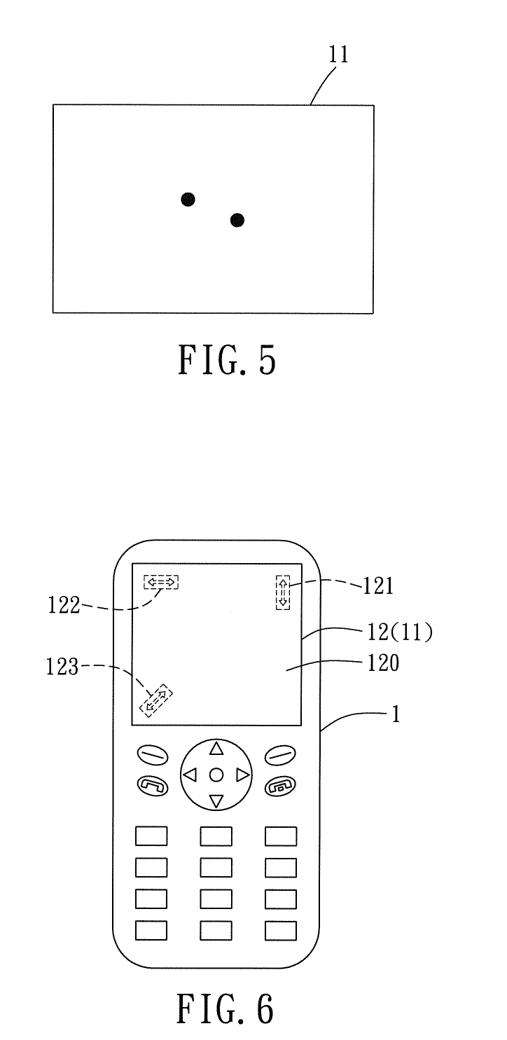

Alternatively, there is another way for the electronic device 1 to exit the scrolling mode and return to the cursor mode. For example, in step 26, it is determined whether there is one of a double-object touch (as shown in FIG. 5), a single-object double tap, a double-object pinching and a single-object dragging touch motion on the touch pad 11 when the electronic device 1 operates in the scrolling mode. If affirmative, the flow goes to step 27, where the electronic device 1 is configured to exit the scrolling mode and enter the cursor mode to perform a function in response to and in correspondence with the one of the double-object touch, the single-object double tap, the double-object pinching, and the single-object dragging touch motion on the touch pad 11. More particularly, when the control module 14 controls the processor 13 to operate in the scrolling mode, upon receipt of the touch signal that indicates one of a double-object touch, a single-object double tap, a double-object pinching and a single-object dragging touch motion on the touch pad 11, the control module 14 controls the processor 13 to exit the scrolling mode and enter the cursor mode, where the processor 13 is enabled to perform a function in correspondence with the one of the double-object touch, the single-object double tap, the double-object pinching and a single-object dragging touch motion on the touch pad 11 with reference to the touch signal. Examples of the function include enlarging or shrinking the visual display 120 displayed on the display screen 12, rotating the visual display 120, selecting an item shown in the visual display 120, etc. The flow continues to go from step 27 back to step 22 to detect the presence of a single-object touch on the touch pad 11, and to determine whether the time interval that the single-object touch remains substantially stationary on the touch pad 11 reaches the predefined first threshold value.

If the result of step 26 is negative, the flow goes to step 23, such that the electronic device 1 remains in the scrolling mode.

A person with ordinary skill in the art should readily appreciate that, although steps 24 and 26 are shown to be simultaneously executed such that the electronic device 1 can exit the scrolling mode and return to the cursor mode when one of the conditions is met, the flow may also be such that one condition is determined before the other condition is determined, e.g., when the result of step 24 is negative, the flow goes to step 26.

According to this embodiment, the electronic device 1 further includes a counter 15 (see FIG. 2) coupled to the control module 14 for keeping track of the time intervals of the touch signal, such as those required for steps 22 and 24.

In addition, the method according to this embodiment optionally includes the step of configuring the electronic device 1 to permit user setting of the predefined first and second threshold values. Accordingly, for the electronic device 1 according to the present invention, the predefined first threshold value may optionally be user-defined.

Moreover, in step 23 of this embodiment, the electronic device 1 is further configured to generate a graphic indication (e.g., 121, 122, 123 of FIG. 6) indicative of scrolling and shown in the visual display 120 displayed on the display screen 12 when the electronic device 1 operates in the scrolling mode. In particular, the processor 13 generates the graphic indication when operating in the scrolling mode. The graphic indication disappears from the visual display 120 when the processor 13 exits the scrolling mode and operates in the cursor mode.

The flow continues as long as the electronic device 1 remains activated.

A person with ordinary skill in the art should readily appreciate that, although FIG. 1 is illustrated to show that the cursor mode is entered when the electronic device 1 is turned on to serve as a default mode, the present invention also encompasses an embodiment in which the scrolling mode serves as the default mode. In other words, the scrolling mode can be entered initially when the electronic device 1 is turned on, and upon determining that a time interval that no touch is detected on the touch pad 11 has reached a predetermined threshold value, or upon determining that there is one of a double-object touch, a single-object double tap, a double-object pinching and a single-object dragging touch motion on the touch pad 11,

the electronic device 1 is configured to exit the scrolling mode and enter the cursor mode. Otherwise, the electronic device 1 is configured to remain in the scrolling mode. For simplicity, further details of this embodiment are omitted.

With reference to FIG. 6, the touch pad 11 of the present invention may be a transparent touch panel that is laid over and coupled electrically to the display screen 12 such that the touch pad 11 and the display screen 12 are integrated into a touch screen. One application for this kind of implementation is when the electronic device 1 is a cellular phone, as illustrated in FIG. 6.

In addition, with reference to FIG. 2, in order to notify the user of the operating mode of the electronic device 1, the electronic device 1 further includes a light indicator 16 coupled to the control module 14. The light indicator 16 is activated by the control module 14 when the processor 13 enters the scrolling mode, and is deactivated by the control module 14 when the processor 13 exits the scrolling mode. Alternatively, the light indicator 16 may emit two different colors of light when the electronic device 1 operates under the two different modes.

In view of the above, according to this embodiment, the decision to enter the scrolling mode from the cursor mode can be made by determining whether the time interval that a single-object touch remains substantially stationary on the touch pad 11 reaches the predefined first threshold value, such that the touch pad 11 does not need to be configured with separate cursor and scrolling zones, thereby saving operating space on the touch pad 11, which is especially important when the touch pad 11 is to be applied to a small electronic device 1. Moreover, since the electronic device 1 is configured to operate in only one of the cursor mode and the scrolling mode at a single point in time, the drawback associated with the prior art, where the scrolling function (i.e., controlling movement of the visual display 120) may be unintentionally activated when performing the cursor function (i.e., controlling movement of the cursor 40) is actually desired or vice versa, may be eliminated.

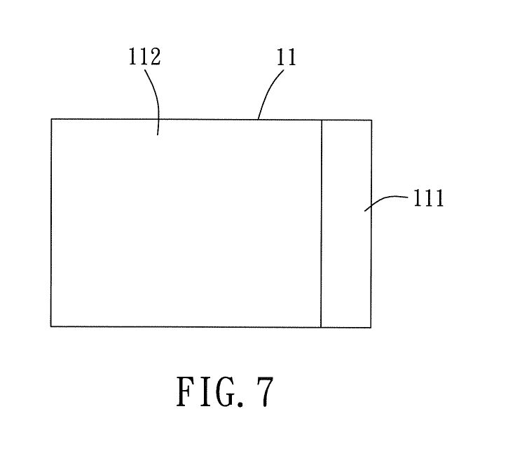

With reference to FIG. 2 and FIG. 7, the electronic device 1 and the method for controlling the electronic device 1 according to the second preferred embodiment of the present invention differs from the previous embodiment in that the touch pad 11 is configured with a scrolling zone 111 and a cursor zone 112. Movement of the cursor 40 in the visual display 120 (as shown in FIG. 3) shown on the display screen 12 is enabled and controlled in response to and in correspondence with a single-object sliding touch motion on the cursor zone 112 of the touch pad 11 when the electronic device 1 operates in the cursor mode. More specifically, the processor 13 of the electronic device 1 controls the movement of the cursor 40 in response to and in correspondence with the touch signal that corresponds to a single-object sliding touch motion on the cursor zone 112 of the touch pad 11 when the processor 13 operates in the cursor mode.

In addition, the single-object touch detected in step 22 (shown in FIG. 1) is on the scrolling zone 111 of the touch pad 11, the time interval determined in step 22 corresponds to that during which the single-object touch remains substantially stationary on the scrolling zone 111 of the touch pad 11, and scrolling of the visual display 120 shown on the display screen 12 is enabled and controlled in response to and in correspondence with a single-object sliding touch motion on the scrolling zone 111 of the touch pad 11 when the electronic device 1 operates in the scrolling mode in step 23. In other words, in step 22, when the control module 14 controls the processor 13 to operate in the cursor mode, upon receipt of the touch signal indicating a single-object touch on the scrolling zone 111 of the touch pad 11, the control module 14 determines whether a time interval that the single-object touch remains substantially stationary on the scrolling zone 111 of the touch pad 11 reaches the predefined first threshold value, and in step 23, the control module 14 controls the processor 13 to exit the cursor mode and enter the scrolling mode when the time interval that the single-object touch remains substantially stationary on the scrolling zone 111 of the touch pad 11 is determined to have reached the predefined first threshold value. Moreover, the time interval determined in step 24 corresponds to a time interval that no touch is detected on the scrolling zone 111 of the touch pad 11.

According to this embodiment, there are the following other ways for the electronic device 1 to exit the scrolling mode and return to the cursor mode.

Upon detecting that there is no touch on the scrolling zone 111 of the touch pad 11 and that there is a touch on the cursor zone 112 of the touch pad 11 when the electronic device 1 operates in the scrolling mode, the electronic device 1 is configured to exit the scrolling mode and return to the cursor mode. More specifically, when the control module 14 controls the processor 13 to operate in the scrolling mode, upon receipt of the touch signal indicating that there is no touch on the scrolling zone 111 of the touch pad 11 and there is a touch on the cursor zone 112 of the touch pad 11, the control module 14 controls the processor 13 to exit the scrolling mode and enter the cursor mode.

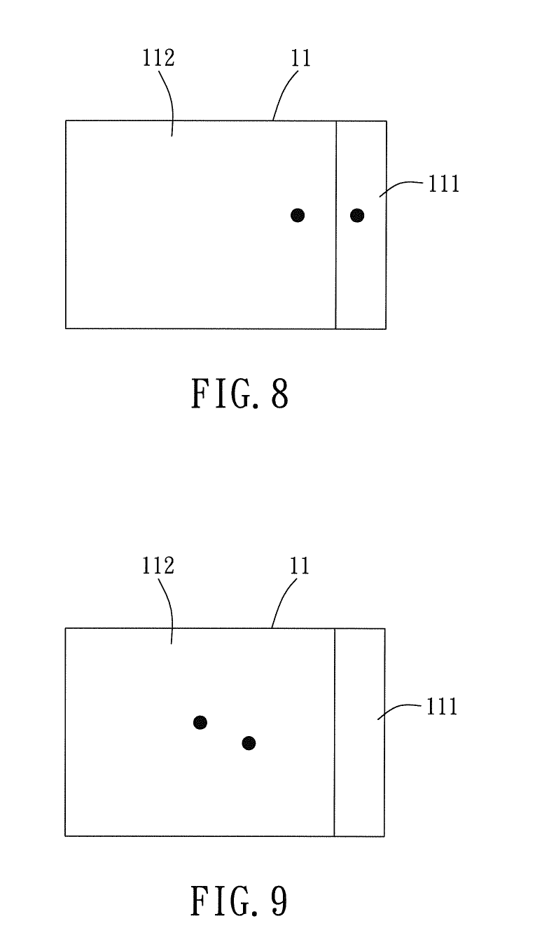

As shown in FIG. 8, upon detecting that there is simultaneously a single-object touch on the cursor zone 112 of the touch pad 11 and a single-object touch on the scrolling zone 111 of the touch pad 11 when the electronic device 1 operates in the scrolling mode, the electronic device 1 is configured to exit the scrolling mode and enter the cursor mode. More specifically, when the control module 14 controls the processor 13 to operate in the scrolling mode, upon receipt of the touch signal indicating that there is simultaneously a single-object touch on the cursor zone 112 of the touch pad 11 and a single-object touch on the scrolling zone 111 of the touch pad 11, the control module 14 controls the processor 13 to exit the scrolling mode and enter the cursor mode.

Furthermore, upon detecting one of a double-object touch (as shown in FIG. 9), a single-object double tap, a double-object pinching and a single-object dragging touch motion on the cursor zone 112 of the touch pad 11 when the electronic device 1 operates in the scrolling mode, the electronic device 1 is configured to exit the scrolling mode and enter the cursor mode to perform a function in response to and in correspondence with the one of the double-object touch, the single-object double tap, the double-object pinching and the single-object dragging touch motion on the cursor zone 112 of the touch pad 11. In particular, when the control module 14 controls the processor 13 to operate in the scrolling mode, upon receipt of the touch signal that indicates one of a double-object touch, a single-object double tap, a double-object pinching and a single-object dragging touch motion on the cursor zone 112 of the touch pad 11, the control module 14 controls the processor 13 to exit the scrolling mode and enter the cursor mode, where the processor 13 is enabled to perform a function in correspondence with the one of the double-object touch, the single-object double tap, the double-object pinching and the single-object dragging touch motion on the cursor zone 112 of the touch pad 11.

It should be noted herein that according to the second preferred embodiment, since there has to be a single-object touch on the scrolling zone 111 that remains substantially stationary for at least the predefined first threshold of time in order for the electronic device 1 to exit the cursor mode and enter the scrolling mode, and since one of the above-mentioned conditions (no touch on the scrolling zone 111 for at least the predefined second threshold of time, simultaneously a single-object touch on each of the cursor and scrolling zones 111, 112, and one of a double-object touch, a single-object double tap, a double-object pinching and a single-object dragging touch motion on the cursor zone 112) has to be satisfied for the electronic device 1 to exit the scrolling mode and enter the cursor mode, if an object (e.g. a user's finger) unintentionally slides over to the scrolling zone 111 from the cursor zone 112 when the electronic device 1 operates in the cursor mode, or if the object accidentally slides over to the cursor zone 112 from the scrolling zone 111 when the electronic device 1 operates in the scrolling mode, the electronic device 1 is able to remain in the current operating mode and not be controlled to perform an unintentional or undesired function (e.g., move the cursor when operating in the scrolling mode, or scroll the visual display 120 when operating in the cursor mode).

Furthermore, in order to accommodate different user habits, the scrolling zone 111 may be user-defined. Accordingly, the method for controlling the electronic device 1 would further include the step of configuring the electronic device 1 to permit user setting of the scrolling zone 111. As a result, the scrolling zone 111 may be defined to be located along a left edge, a right edge, a top edge or a bottom edge of the touch pad 11. Alternatively, the user may define more than one scrolling zone 111, such as one scrolling zone 11 along a lateral edge (one of the top and bottom edges) and one scrolling zone 111 along a vertical edge (one of the right and left edges) of the touch pad 11 to facilitate convenient scrolling of the visual display 120 in lateral and vertical directions. In another implementation, the user may define the scrolling zone 111 along a longer edge (e.g., a lateral edge), and define that the scrolling zone 111, while being along the lateral edge, is used to control movement of the visual display 120 in a vertical direction, so as to increase the distance and space for scrolling control.

To sum up, the present invention provides a method for controlling an electronic device and an electronic device 1 that substantially prevent unintentional control of an undesired one of a scrolling function and a cursor function and that enhance operational convenience.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for controlling an electronic device that includes a touch pad and a display screen, the method comprising the steps of:
(A) upon detecting a single-object touch on the touch pad when the electronic device operates in a cursor mode, where movement of a cursor in a visual display displayed on the display screen is enabled and controlled in response to and in correspondence with a single-object sliding touch motion on the touch pad, configuring the electronic device to determine whether a time interval that the single-object touch remains substantially stationary on the touch pad reaches a predefined first threshold value; and
(B) when it is determined that the time interval that the single-object touch remains substantially stationary on the touch pad reaches the predefined first threshold value, configuring the electronic device to exit the cursor mode and enter a scrolling mode, where scrolling of the visual display displayed on the display screen is enabled and controlled in response to and in correspondence with a single-object sliding touch motion on the touch pad.

2. The method for controlling an electronic device as claimed in claim 1, further comprising the step of:
(C) when it is determined that the time interval that the single-object touch remains substantially stationary on the touch pad has not reached the predefined first threshold value, configuring the electronic device to remain in the cursor mode.

3. The method for controlling an electronic device as claimed in claim 1, further comprising the step of:
(D) upon determining that a time interval that no touch is detected on the touch pad reaches a predefined second threshold value when the electronic device operates in the scrolling mode, configuring the electronic device to exit the scrolling mode and return to the cursor mode.

4. The method for controlling an electronic device as claimed in claim 3, further comprising the step of:
(E) configuring the electronic device to permit user setting of the predefined first and second threshold values.

5. The method for controlling an electronic device as claimed in claim 1, further comprising the step of:
(F) upon detecting one of a double-object touch, a single-object double tap, a double-object pinching and a single-object dragging touch motion on the touch pad when the electronic device operates in the scrolling mode, configuring the electronic device to exit the scrolling mode and enter the cursor mode to perform a function in response to and in correspondence with said one of the double-object touch, the single-object double tap, the double-object pinching and the single-object dragging touch motion on the touch pad.

6. The method for controlling an electronic device as claimed in claim 1, the touch pad being configured with a scrolling zone and a cursor zone, wherein movement of the cursor in the visual display shown on the display screen is enabled and controlled in response to and in correspondence with a single-object sliding touch motion on the cursor zone of the touch pad when the electronic device operates in the cursor mode.

7. The method for controlling an electronic device as claimed in claim 1, the touch pad being configured with a scrolling zone and a cursor zone, wherein the single-object touch detected in step (A) is on the scrolling zone of the touch pad, the time interval determined in step (B) corresponds to a time interval that the single-object touch remains substantially stationary on the scrolling zone of the touch pad, and scrolling of the visual display shown on the display screen is enabled and controlled in response to and in correspondence with a single-object sliding touch motion on the scrolling zone of the touch pad when the electronic device operates in the scrolling mode.

8. The method for controlling an electronic device as claimed in claim 7, further comprising the step of:
(G) upon detecting that there is no touch on the scrolling zone of the touch pad and that there is a touch on the cursor zone of the touch pad when the electronic device operates in the scrolling mode, configuring the electronic device to exit the scrolling mode and enter the cursor mode.

9. The method for controlling an electronic device as claimed in claim 7, further comprising the step of:
(H) upon detecting that there is simultaneously a single-object touch on the cursor zone of the touch pad and a single-object touch on the scrolling zone of the touch pad when the electronic device operates in the scrolling mode, configuring the electronic device to exit the scrolling mode and enter the cursor mode.

10. The method for controlling an electronic device as claimed in claim 7, further comprising the step of:
(I) upon detecting one of a double-object touch, a single-object double tap, a double-object pinching and a single-object dragging touch motion on the cursor zone of the touch pad when the electronic device operates in the scrolling mode, configuring the electronic device to exit the scrolling mode and enter the cursor mode to perform a function in response to and in correspondence with said one of the double-object touch, the single-object double tap, the double-object pinching and the single-object dragging touch motion on the cursor zone of the touch pad.

11. The method for controlling an electronic device as claimed in claim 7, further comprising the step of:
(J) configuring the electronic device to generate a graphic indication indicative of scrolling and shown in the visual display displayed on the display screen when the electronic device operates in the scrolling mode.

12. The method for controlling an electronic device as claimed in claim 7, further comprising the step of:
(K) configuring the electronic device to permit user setting of the scrolling zone.

13. An electronic device, comprising:
a touch pad for generating a touch signal;
a display screen for displaying a visual display thereon;
a processor coupled to said touch pad for receiving the touch signal, and further coupled to said display screen for generating the visual display to be displayed on said display screen, said processor enabling and controlling movement of a cursor in the visual display in response to and in correspondence with the touch signal that corresponds to a single-object sliding touch motion on said touch pad when said processor operates in a cursor mode, said processor enabling and controlling scrolling of the visual display in response to and in correspondence with the touch signal that corresponds to a single-object sliding touch motion on said touch pad when said processor operates in a scrolling mode; and
a control module coupled to said touch pad for receiving the touch signal therefrom, and further coupled to said processor for controlling operation of said processor in one of the cursor mode and the scrolling mode;
wherein when said control module controls said processor to operate in the cursor mode, upon receipt of the touch signal indicating a single-object touch on said touch pad, said control module determines whether a time interval that the single-object touch remains substantially stationary on said touch pad reaches a predefined first threshold value with reference to the touch signal, and controls said processor to exit the cursor mode and enter the scrolling mode when the time interval that the single-object touch remains substantially stationary on said touch pad is determined to have reached the predefined first threshold value.

14. The electronic device as claimed in claim 13, wherein the predefined first threshold value is user-defined.

15. The electronic device as claimed in claim 13, wherein when said control module controls said processor to operate in the scrolling mode, upon receipt of the touch signal that indicates one of a double-object touch, a single-object double tap, a double-object pinching and a single-object dragging touch motion on said touch pad, said control module controls said processor to exit the scrolling mode and enter the cursor mode, where said processor is enabled to perform a function in correspondence with said one of the double-object touch, the single-object double tap, the double-object pinching and the single-object dragging touch motion on said touch pad with reference to the touch signal.

16. The electronic device as claimed in claim 13, wherein:
said touch pad is configured with a scrolling zone and a cursor zone;
said processor controls the movement of the cursor in the visual display displayed by said display screen in response to and in correspondence with the touch signal that corresponds to a single-object sliding touch motion on said cursor zone of said touch pad when said processor operates in the cursor mode.

17. The electronic device as claimed in claim 13, wherein:
said touch pad is configured with a scrolling zone and a cursor zone; and
when said control module controls said processor to operate in the cursor mode, upon receipt of the touch signal indicating a single-object touch on said scrolling zone of said touch pad, said control module determines whether a time interval that the single-object touch remains substantially stationary on said scrolling zone of said touch pad reaches the predefined first threshold value, and controls said processor to exit the cursor mode and enter the scrolling mode when the time interval that the single-object touch remains substantially stationary on said scrolling zone of said touch pad is determined to have reached the predefined first threshold value.

18. The electronic device as claimed in claim 17, wherein said scrolling zone is user-defined.

19. The electronic device as claimed in claim 17, wherein when said control module controls said processor to operate in the scrolling mode, upon receipt of the touch signal indicating that there is no touch on said scrolling zone of said touch pad and there is a touch on said cursor zone of said touch pad, said control module controls said processor to exit the scrolling mode and enter the cursor mode.

20. The electronic device as claimed in claim 17, wherein when said control module controls said processor to operate in the scrolling mode, upon receipt of the touch signal indicating that there is simultaneously a single-object touch on said cursor zone of said touch pad and a single-object touch on said scrolling zone of said touch pad, said control module controls said processor to exit the scrolling mode and enter the cursor mode.

21. The electronic device as claimed in claim 17, wherein when said control module controls said processor to operate in the scrolling mode, upon receipt of the touch signal that indicates one of a double-object touch, a single-object double tap, a double-object pinching and a single-object dragging touch motion on said cursor zone of said touch pad, said control module controls said processor to exit the scrolling mode and enter the cursor mode, where said processor is enabled to perform a function in correspondence with said one of the double-object touch, the single-object double tap, the double-object pinching and the single-object dragging touch motion on said cursor zone of said touch pad.

22. The electronic device as claimed in claim 13, further comprising a light indicator coupled to said control module, said light indicator being activated by said control module when said processor enters the scrolling mode, and being deactivated by said control module when said processor exits the scrolling mode.

23. The electronic device as claimed in claim 13, wherein said touch pad is a transparent touch panel that is laid over and coupled electrically to said display screen such that said touch pad and said display screen are integrated into a touch screen.

24. The electronic device as claimed in claim 23, wherein said processor generates a graphic indication indicative of scrolling and shown in the visual display displayed by said display screen when said processor operates in the scrolling mode.

25. The electronic device as claimed in claim 13, wherein when said control module controls said processor to operate in the scrolling mode, upon determining that a time interval that the touch signal indicating that no touch is detected on said touch pad has reached a predefined second threshold value, said control module controls said processor to exit the scrolling mode and return to the cursor mode.

26. The electronic device as claimed in claim 25, further comprising a counter coupled to said control module, said counter keeping track of the time intervals of the touch signal.

27. The electronic device as claimed in claim 25, wherein the predefined first and second threshold values are user-defined.

28. The electronic device as claimed in claim 13, wherein the cursor mode is a default mode.
